(19) United States
(12) Patent Application Publication
(10) Pub. No.: US 2005/0134220 A1
(43) Pub. Date: Jun. 23, 2005

(54) Area-efficient compensation circuit and method for voltage mode switching battery charger

(76) Inventors: Paul L. Brohlin, Neufahrn (DE); Robert Martinez, Lucas, TX (US); Richard K. Stair, Richardson, TX (US)

Correspondence Address: TEXAS INSTRUMENTS INCORPORATED, P O BOX 655474, M/S 3999, DALLAS, TX, 75265, US

(21) Appl. No.: 10/995,742

(22) Filed: Nov. 22, 2004

Related U.S. Application Data
(60) Provisional application No. 60/524,193, filed on Nov. 21, 2003.

(51) Int. Cl. H02J 7/00

(52) U.S. Cl. 320/128

(57) ABSTRACT

A feedback-controlled battery charger circuit (500) provides, alternatively, constant current and constant voltage to a battery (328) being charged. Current and voltage at the charger output (326) are sensed in sensing elements (308) and compared to preset reference values from reference generators for current (330) and voltage (332), thus generating error signals for both current and voltage. These error signals are amplified in separate amplifiers (530, 534); then, depending on battery voltage, one of the amplified error signals is automatically selected by a signal selector (540). The selected error signal is applied to a single compensation amplifier (554) with reactive feedback loop (552, 556); the output of the compensation amplifier with feedback (504) then controls the output current or voltage of the output stage (306). This output stage is a voltage controlled current source. The output of this voltage controlled current source is connected through an output filter (318) and sensing elements (308) to the battery (328) being charged.

### CROSS-REFERENCE TO RELATED APPLICATIONS

This application claims priority under 35 U.S.C. 119 of U.S. Patent Application Ser. No. 60/524,193, filed Nov. 21, 2003, entitled “Area-Efficient Compensation Method for Voltage-Mode Switching Battery Chargers,” the entirety of which is incorporated herein by reference.

### BACKGROUND OF THE INVENTION

1. Field if the Invention

This invention relates to battery chargers in general, and, in particular, to a compensation method for a dual voltage mode, constant current constant voltage (CC-CV), DC-DC step-down switching battery charger using negative feedback for regulation of charging current and voltage.

2. Description of the Related Art

Modern battery chargers are designed to accurately regulate both charging current and charging voltage. One class of chargers is referred to as constant-current, constant-voltage (CC-CV) chargers.

Lithium (Li+) battery chargers follow a predetermined charging profile to ensure safe operation for the user and optimal charging of the battery. This profile calls for constant current during the bulk charging phase, followed by constant voltage once the battery voltage reaches a preset level. Regulating both current and voltage requires two feedback control loops. In the design of a charger, some of the challenging tasks are (1) compensating these feedback loops, (2) smoothly transitioning between the current loop and the voltage loop, and (3) minimizing the size of compensation components for these loops.

One known solution, as described in U.S. Pat. No. 6,570,372 issued May 27, 2003, the entirety of which is incorporated herein by reference, uses an active compensation amplifier with associated feedback components for each of current and voltage. While this approach has the advantages of an active compensation amplifier, including ratiometric gain setting and small passive components, it requires two amplifiers and two sets of passive feedback components, with the resulting die size and cost penalties.

A second known solution, as described in U.S. Pat. No. 6,166,521 issued Dec. 26, 2000, the entirety of which is incorporated herein by reference, uses a transconductance amplifier for each of current and voltage error amplifiers, followed by a summation network and single passive compensation network. The component values in this passive network are too large to be integrated and must be external to the die. Another drawback of this approach is the variability in gain of the transconductance amplifiers with process and temperature variation.

Additional background may be found in U.S. Pat. Nos. 6,697,685; 6,570,372; 6,366,056; 6,166,521; 6,137,265; 6,100,667; 5,723,970; 5,710,506; and 5,670,863.

### SUMMARY OF THE INVENTION

The invention provides an apparatus and method for a feedback-controlled constant-current, constant-voltage (CC-CV) battery charger. An automatic signal selector determines which of an amplified voltage error or amplified current error to connect to a following common active compensation amplifier. Advantages over known art include reduction in required die area, ability to integrate compensation components, and improved compensation amplifier performance.

In an embodiment of the invention described in greater detail below, a common compensation amplifier is used for both current and voltage feedback loops, each loop being used alternatively to control its output parameter (current or voltage). The frequency and phase response tailoring components in the compensation network are in a feedback configuration around the compensation amplifier, allowing much smaller component values and further reducing die area. Further, the amplitude and phase response of the compensation amplifier with such feedback are a function of component ratios rather than absolute values, yielding much more accurate and repeatable gain and phase characteristics. Both the current sensing and voltage sensing points in the circuit follow the output filter of the DC-DC converter, allowing use of the same compensation amplifier for both parameters. A signal selector automatically selects the appropriate one of the two error signals (voltage or current), and presents the selected error signal to the compensation amplifier.

As further described below, the disclosed topology provides a combination of desirable properties not available in the known art, including 1) lower component count, from the use of a single compensation amplifier and feedback network, resulting in smaller die area; 2) active compensation with ratiometric feedback, which reduces the impact of open-loop gain variation in the compensation or input error amplifiers; 3) voltage sense and current sense elements both within the overall system feedback loop, allowing amplitude and phase response of a single compensation network to be optimized for both current and voltage control; and 4) automatic signal selector which determines whether voltage control or current control is required, and automatically selects the appropiate errorsignal to be included in the feedback loop.

Further benefits and advantages will become apparent to those skilled in the art which the invention relates.

### DESCRIPTION OF THE VIEWS OF THE DRAWINGS

FIG. 1 (prior art) is a block diagram of a charger of the type to which the disclosures relate.

FIG. 2 (prior art) is a graph of a typical charging profile of a Lithium Ion (Li+) battery.

FIG. 3 (prior art) is a block diagram of a known DC-DC converter providing compensation using two separate compensation networks.

FIG. 4 (prior art) is a block diagram of a known DC-DC converter providing compensation using transconductance amplifiers and passive compensation.

FIG. 5 is a block of a DC-DC converter employing the principles of the invention.

FIG. 6 is a circuit diagram of an example implementation of the converter shown in FIG. 5.

Through the drawings, like elements are referred to by like numerals.

### DETAILED DESCRIPTION

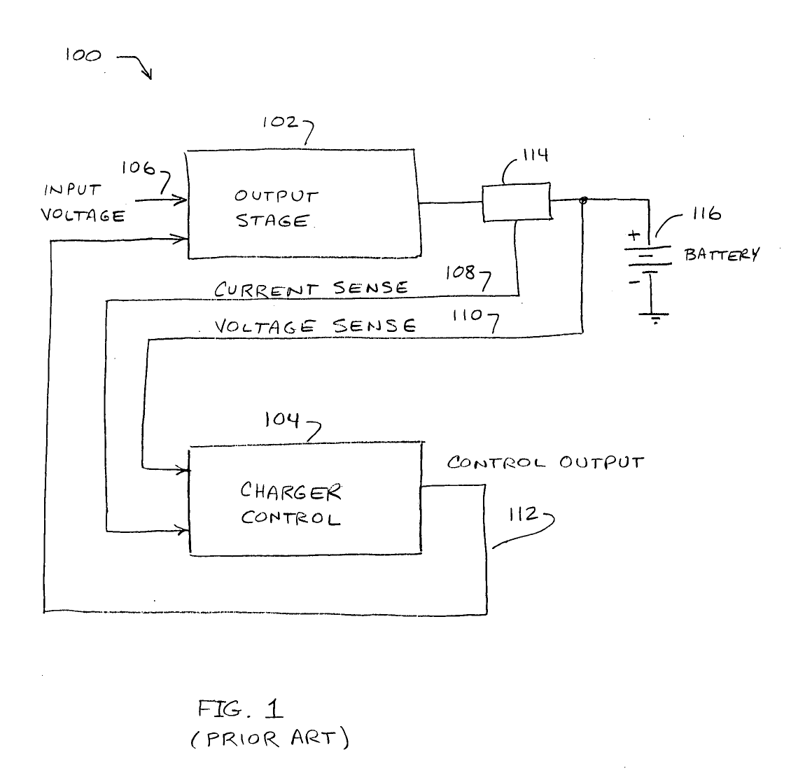

As shown in FIG. 1, a typical battery charger 100 has an input voltage applied to the input 106 of an output stage 102. Output stage 102 is a voltage-controlled current source (VCCS) which serves to regulate the flow of current from input 106 to a battery 116 which is to be charged. Battery charging current is sensed by a sensor 114 at the output of output stage 102. Sensor 104 outputs a voltage representing the charging current to a first input 108 of a charger control circuit 104. Voltage on the battery 116 is also sensed, and is applied to a second input 110 of charger control circuit 104. Charger control circuit 104 is adapted and configured in response to the inputs 108, 110, to determine whether a constant current or constant voltage should be applied to the battery 116 being charged. In response to this determination, a control signal is applied by way of feedback to a control input 112 of the VCCS 102, to set the current into or voltage applied to battery 116 (as appropriate) at a selected level. Constant current is applied if the battery voltage is below its target fully-charged voltage; constant voltage is applied when the battery voltage reaches its target fully-charged voltage.

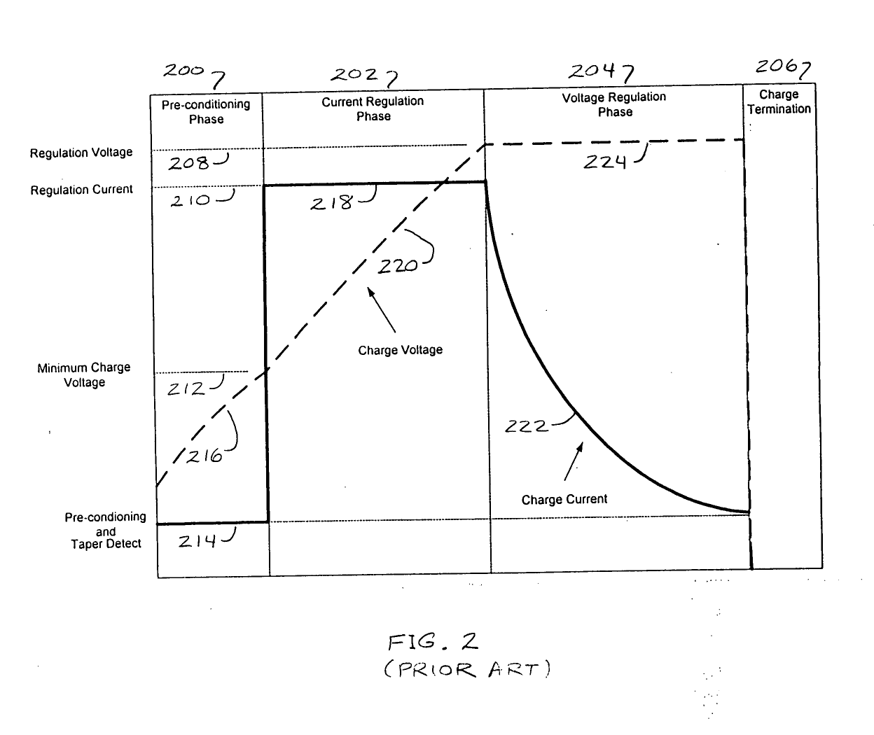

The charging profile for a typical Li+ battery is detailed in FIG. 2. A pre-conditioning phase 200 begins the charging process, during which a low current 214 is applied by output stage 102 to the battery 116 being charged. As a result of the applied current 214, the voltage on battery 116 gradually increases as shown by 216, until it reaches a minimum charge voltage level 212. At this point, a current regulation phase 202 begins wherein the charge current is increased to a constant regulation current level 210, and the battery charge voltage (applied at 110) continues to increase as shown at 220, until reaching the regulation or target voltage 208. At this time, the charger enters a voltage regulation phase 204 wherein a constant regulation voltage 208 is applied to the battery 106, preventing battery voltage from exceeding the target voltage value. Charge current begins to decrease in phase 204, as shown at 222, as battery 106 approaches its full charge. When the charging current reaches a preset minimum level 214, charging is terminated, at 206.

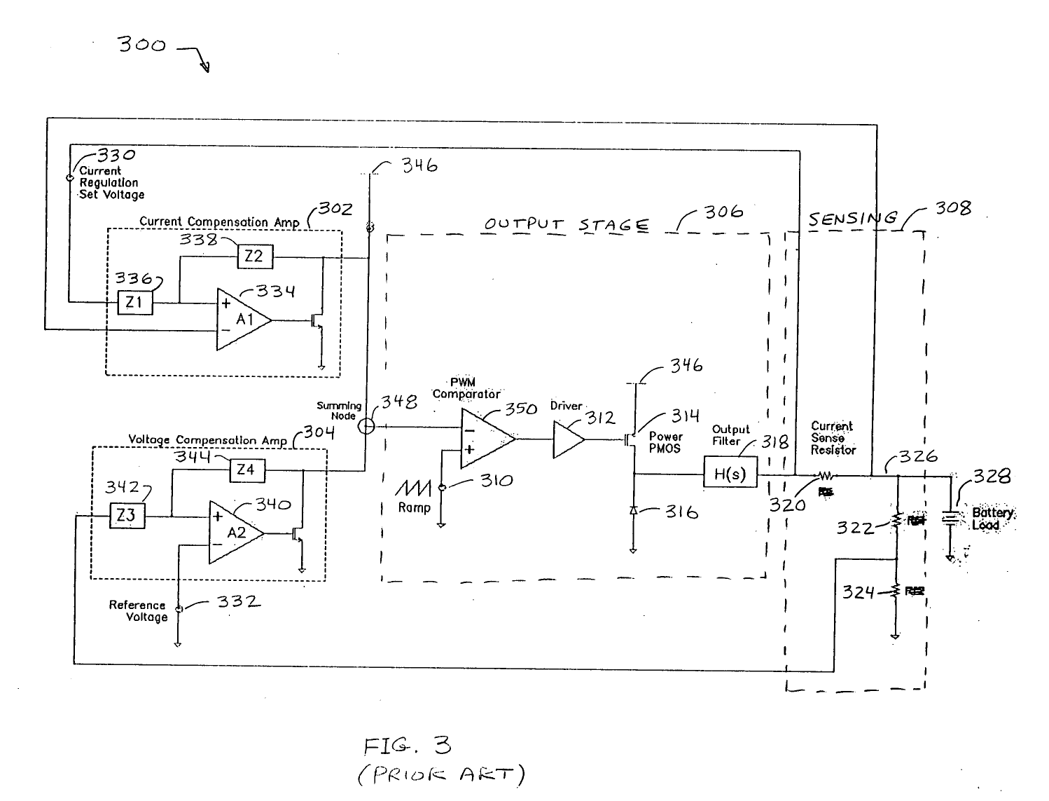

FIG. 3 shows a known battery charger 300 that employs two active compensation amplifiers. Charging current is provided to a battery load 328 (corresponding to battery 116 in FIG. 1) from a supply 346 by an output stage 306 (analogous to output stage 102 of FIG. 1) comprising a power MOSFET transistor 314 and diode 316 connected as shown, with an output filter 318 with transfer function H(s) serving to smooth the flow of current. The amount of average current is controlled by the duty cycle of a square wave generated by a pulse-width-modulation (PWM) comparator 350 which drives the gate of transistor 314 by means of a driver 312. The comparator has two inputs, one connected to a summing node 348 and one connected to receive a ramp signal from a ramp generator 310. For sensing the charge current and charge voltage, a sensing stage 308 is provided at the output of stage 306. During the constant current (CC) mode (current regulation phase 202 in FIG. 2), the voltage developed across a current sense resistor 320 (analogous to sensor 114 and connected in series with filter 318 at the output of stage 306), is indicative of the charge current applied to the load 328. A reference voltage 330, set to the voltage representing the desired charging current in CC mode, is connected in series with the voltage generated by the resistor, and is subtracted from it. This differential between the voltage of resistor 320 and the reference voltage 330 is applied as an input voltage to a current compensation amplifier 302, the reference voltage 330 being set so that the differential is zero when the charge current is at its target value. An amplifier 334 and feedback components 336 and 338 are connected as shown to form an error amplifier for the current error. Similarly, a fraction of the output voltage, set by a voltage divider comprising a resistor 322 and a resistor 324, is fed back as an input to a voltage compensation amplifier 304, where it is compared in amplifier 340 to a reference voltage from a reference generator 332 representing the desired regulation voltage for a constant voltage CV mode (in the voltage regulation phase 204 of FIG. 2). Feedback components 342 and 344, connected as shown, control the gain of the resulting error amplifier for the regulation voltage. The outputs of both compensation amplifiers 302, 304 are summed at a summing node 348 which, as previously indicated, serves as an input (shown as the inverted input) to the PWM comparator 350, thereby controlling the duty cycle of (and average current through) power PMOS transistor 314. This topology has the advantage of having an active compensation amplifier, but the disadvantage of requiring two compensation amplifiers and two sets of reactive components, greatly increasing die size or requiring the use of external components.

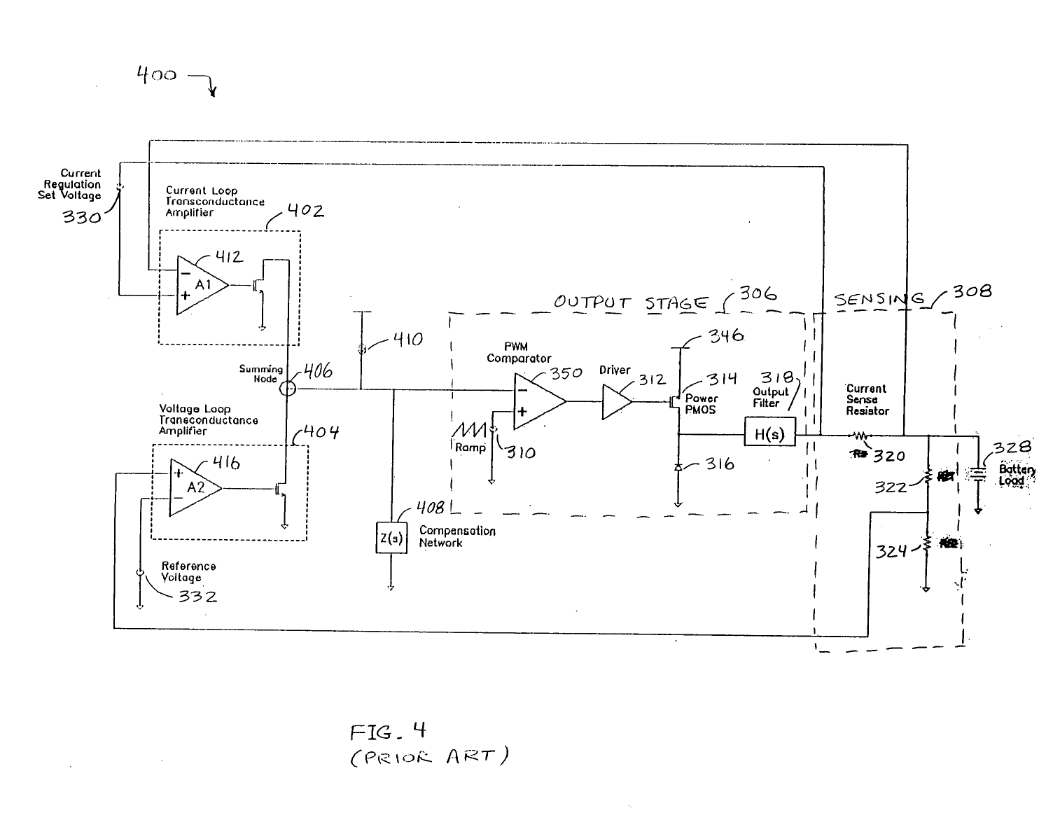

FIG. 4 shows another known battery charger 400 that employs two transconductance amplifiers and a single passive compensation network. It has an output stage 306 and a sensing stage 308 whose configurations and operations are identical with those of corresponding stages 306, 308 of charger 300 of FIG. 3, described above. A current loop transconductance amplifier 402 and a voltage loop transconductance amplifier 404 generate error voltages for current and voltage respectively. Unlike the amplifiers 302, 304 of charger 300 (see FIG. 3), there is no feedback from the outputs to the inputs of error amplifiers 402 and 404, so they amplify (modify amplitude and phase response) but do not compensate the error signals. The error signal outputs are summed at a summing node 406 and applied to a passive compensation network 408, as shown. Source 410 serves the same function as source 346. The topology of charger 400 has the advantage that it uses a single compensation network, but this network has much larger component values for reactive elements than the active compensation charger 300 of FIG. 3. In charger 400, passive compensation is performed after summing the currents at node 406 from the voltage and current error amplifiers 402, 404. One disadvantage of this topology is that the gain of the feedback loops is largely dependent upon the transconductance of NMOS transistors in the error amplifiers, which can vary significantly with process and temperature. Typically, current through these NMOS transistors is made large to increase gain. This causes the output (driving) impedance of the amplifier to be low. Passive compensation components (for example, a capacitor) connected to the amplifier output are typically low reactance (large capacitance value, large physical size) and external to the integrated circuit. Another disadvantage of this topology is that the passive compensation network limits amplifier performance.

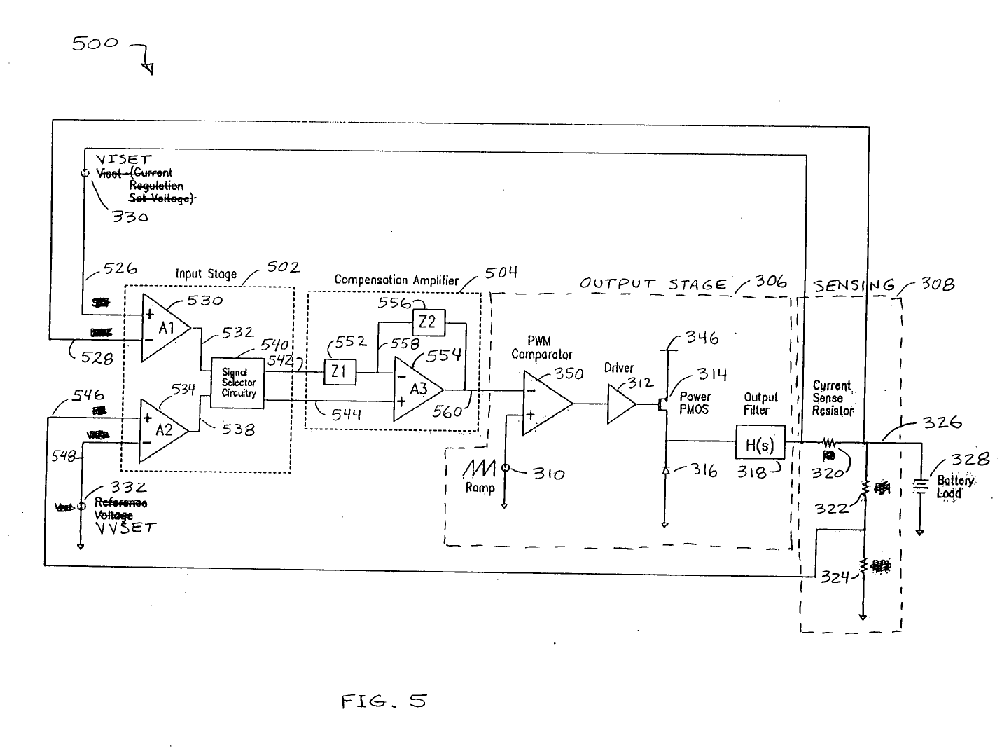

FIG. 5 illustrates a charger incorporating the principles of the invention. In FIG. 5, a DC-to-DC step-down converter 500 comprises an input stage 502, a compensation amplifier 504, an output stage 306, a sensing stage 308, a current reference 330, and a voltage reference 332, configured as shown, to retain the advantages of active compensation while requiring only a single, common compensation amplifier and a single, common set of reactive elements, for reduced die size and improved performance over the known art. For comparison purposes, like elements of FIGS. 3, 4 and 5 are given like numbers.

The battery 328 to be charged requires a constant current (CC) during the first phase of charging (phase 202 in FIG. 2), and a constant voltage (CV) during the second phase of charging (phase 204 in FIG. 2). When the battery voltage is below a certain desired target value equal to its fully-charged voltage 208, constant current 218 of a precise amount appropriate to the battery being charged is applied. When the battery voltage just exceeds this target value 208, a shift to constant voltage mode (204) occurs. The battery charger 500 thus determines which mode to use based on the voltage of the battery 328 it is charging. Means 308 for sensing both the current flowing into the battery, and the voltage applied to the battery, are therefore required. The sensed values of current or voltage are compared to preset reference levels 330, 332 for each (appropriate to the battery being charged), and a feedback loop with high gain is used to drive the output current or voltage to its desired target value.

Current flowing into the battery 328 is sensed by resistor 320 in the sensing stage 308. The current through resistor 320 is nearly equal to the current I_{BAT} flowing into the battery, since resistor 322 and input 528 to amplifier 530 of input stage 502 both have very high impedance. The voltage drop across resistor 320 is therefore, by Ohm's law, essentially equal to IBAT times the resistance of resistor 320.

During the CC mode of operation 202, the current flowing through resistor 320 and hence into battery 328 is accurately controlled. A voltage V_{ISET} across resistor 320 occurs when the current is at its target value. The voltage across resistor 320 increases as current deviates above the desired value, and decreases as current deviates below the desired value. The current regulation set voltage at voltage source 330 is set to V_{ISET} and serves, as previously described, to subtract V_{ISET} from the voltage across resistor 320 applied as an input to the amplifier 530. The differential voltage at input 526 and input 528 of amplifier 530 is thus near zero when the current into the battery 328 is at its target value. Amplifier 530 then amplifies this error voltage so that relatively small deviations in current away from the target value develop fairly large voltage swings at the output 532 of amplifier 530.

Similarly, during CV mode 204, the voltage applied to the battery 328 at output 326 is controlled. As with the configurations of FIGS. 3 and 4, a series connection of resistor 322 and resistor 324, connected between the output 326 and ground, together form a voltage divider in FIG. 5. The voltage from the common node between resistors 322, 324 is applied as an input 546 to amplifier 534. Because the current into amplifier 534 at input 546 is negligible, this divider provides a fractional indication of the battery 328 voltage to input 546 (the non-inverting input) of amplifier 534. A reference voltage V_{VSET} is applied at 332 as a reference voltage to input 548 (the inverting input) of amplifier 534.

The value of V_{VSET} is chosen so that a voltage V_{VSET} is present at input 546 of amplifier 534 when the desired target output voltage (208 in FIG. 2) is present at output 326. Voltage source 332 generates a stable reference voltage equal to this V_{VSET}, which is connected to input 548 of amplifier 534. Thus, the differential input to amplifier 534 is zero when the voltage at output 326 is at its target value for CV mode 204. Amplifier 534 then amplifies this error voltage, so that small deviations from the target value in voltage at output 326 develop large voltage swings at the output 538 of amplifier 534.

Current and voltage error amplifiers 530 and 534 can be chosen to have gain of typically 10 to 20 dB, amplifying respectively the errors in battery current (during CC mode 202) or output voltage (during CV mode 204). The error voltage to be used at a given time, either from amplifier 530 or amplifier 534, depends on whether the CC or CV mode is called for, as determined by the battery voltage at output 326.

Output 532 of amplifier 530 and output 538 of amplifier 534 are provided as inputs to a signal selection circuit 540. This circuit may be configured and adapted to function like an ideal diode “OR” circuit, to pass to an output 542 the higher of the two voltages at its inputs 532, 538. During the CC mode 202, the battery voltage is below the desired target; hence the voltage at output 538 of amplifier 534 is near zero. The charge current is driven to its target level, causing the differential input of amplifier 530 to be near zero, and the output 532 of amplifier 530 to be at whatever voltage causes the desired target current in resistor 320. Signal selector circuitry 540 then passes this voltage from input 532 to output 542, as it is the higher of the two voltages. The voltage at 542 thus serves as an error voltage, representing the difference between the desired current and the actual current, and can swing over a wide range while remaining above the near-zero voltage at 538 from amplifier 534.

During the CC mode 202, the battery voltage continues to rise according to the battery charging characteristic curve (see 220 in FIG. 2), eventually nearing the desired fully-charged voltage 208. As it reaches this target voltage 208, the output 538 of amplifier 534 rises until it exceeds the output 532 of amplifier 530. When the output voltage from amplifier 534 exceeds that from amplifier 530, the output 538 of amplifier 534 dominates (is higher) and is passed through to the output 542 of signal selector circuitry 540. At this time, error amplifier 534 takes control, reducing the charge current as needed (see 222 in FIG. 2) to maintain a constant voltage 224 at output 326. As soon as the output current is reduced even slightly, the output 532 of amplifier 530 falls to near zero due to its now-negative differential input voltage, and the CV mode 204 is active.

The smooth transition from CC mode 202 to CV mode 204 is thereby advantageously handled automatically and in a stable manner. Additionally, in the case where both voltage and current parameters are above their respective target values, operation of the circuit correctly drives both downward until one or the other reaches its set point. This behavior is important in the case, for example, where the load is a capacitor only, with no battery connected.

The error voltage 542 at the output of the signal selector circuitry 540, in either CC or CV mode, is further amplified and filtered in a compensation amplifier stage 504 which comprises an amplifier 554 and negative feedback elements 552 and 556 connected as shown. Elements 552 and 556 are resistive and/or reactive components which set the gain and phase response of amplifier 504. If elements 552 and 556 are resistive only, the frequency and phase response are essentially flat; if elements 552 and/or 556 include capacitance or inductance, a non-flat response is achieved. Providing a control loop with a non-flat response can insure closed-loop stability. The DC gain of the compensation amplifier stage 504 is advantageously set, in conjunction with the gain of the input stage 502, to cause a large error voltage to be generated with even a very small deviation from the desired target current (in CC mode 202) or target voltage (in CV mode 204). The amplitude and phase response of the compensation amplifier 504 is frequency dependent and compensates for the phase shift in the output filter 318, providing system stability and rapid but controlled response to transients away from target current or voltage.

The single, common compensation amplifier 504 as used in the illustrated embodiment of FIG. 5 has a significant advantage over those prior art topologies which use two separate compensation amplifiers, especially when reactive components are used in each loop to tailor phase and frequency response. Some of these reactive components may be physically too large to be integrated. It is advantageous to not only use a single shared compensation amplifier, but also to maximize the required reactance (hence minimizing capacitance value and physical size) needed to achieve the desired filtering, and minimize driving current. Gain accuracy of the compensation amplifier is also an important consideration, to provide consistency in operation from one device to the next. As is well known, the gain of an integrated amplifier comprising MOS transistors varies widely, due to variations in the gain of individual transistors and process variations. One classic approach to reducing such gain variation is the use of negative feedback around an amplifier with high open-loop gain. The gain of the amplifier with such feedback is essentially set by the ratio of the feedback reactance to the input reactance (reactance of 556 divided by reactance of 552 in FIG. 5). This ratiometric feedback minimizes the impact on gain of amplifier variation. The prior-art transconductance amplifier typically has wide variation in parameters which significantly affect overall response of the compensated amplifier. Also, the typical low output impedance of the transconductance amplifiers requires a lower reactance capacitor (higher value, larger physical size) than the equivalent compensation amplifier using ratiometric feedback.

An active compensation network can use reactive elements (for example, capacitors) with much smaller values (hence, physical size) than known passive topologies. This is because the input impedance of the amplifier 554 at input 558 is very high, allowing high-value resistors in the case where element 552 is a resistor. When element 556 is a capacitor, the amplitude response of the compensation amplifier 504 decreases with increasing frequency (low-pass filter), while phase shift increases with increasing frequency. This resistor-capacitor integrator network is commonly used for low-pass filtering and phase response tailoring in a control system such as the present disclosure.

The output of compensation amplifier 504 is connected as an input to the inverting input of the PWM (pulse-width-modulation) comparator 350. The non-inverting input of PWM comparator 350 is driven by a saw tooth ramp generator 310, with amplitude suitably chosen to be roughly equal to the voltage swing at output 560 of amplifier 554. The output of PWM comparator 350 is therefore a square wave which has a duty cycle directly related to the error voltage at output 560, and which ranges about from 0% to 100%. This square wave is buffered by driver 312, the output of which drives the gate of the power PMOS transistor 314, which has its source connected to the supply voltage 346. As the battery current or voltage deviates from its nominal target value, the duty cycle of current flow in transistor 314 varies from (or from nearly) 0% to 100%. When transistor 314 is conducting, it provides current through output filter 318 and resistor 320 to the output 326 (and hence to charge the battery 328). The amount of average current flowing into battery 328 is directly controlled by the conducting duty cycle of transistor 314. When transistor 314 is turned off (non-conducting), diode 316 provides a path for current to flow from ground to output filter 318.

The current pulses provided by transistor 314 are filtered by output filter 318, which is, in the example embodiment, a series inductor driving a capacitor to ground. This filter greatly reduces the ripple current flowing from output 326, reducing the ripple voltage impressed on the battery due to its internal impedance. The output of the output filter 318 is connected to the input of resistor 320.

Though not a requirement, the illustrated output filter 318 precedes the current sense resistor 320. The phase and frequency response of the output filter is therefore inside the current sense control loop. This filter, in conjunction with the filter formed by feedback networks 556, 552 around amplifier 554, thus provides a second-order loop response in the CC mode 202. Because the voltage sense point at input 546 is also after the output filter 318, a second-order response is achieved in CV mode 204, as well. Having the current sense and voltage sense elements both after the output filter is another advantage of the disclosed embodiment over known art. It allows optimization of the single compensation amplifier for both CC and CV modes of operation.

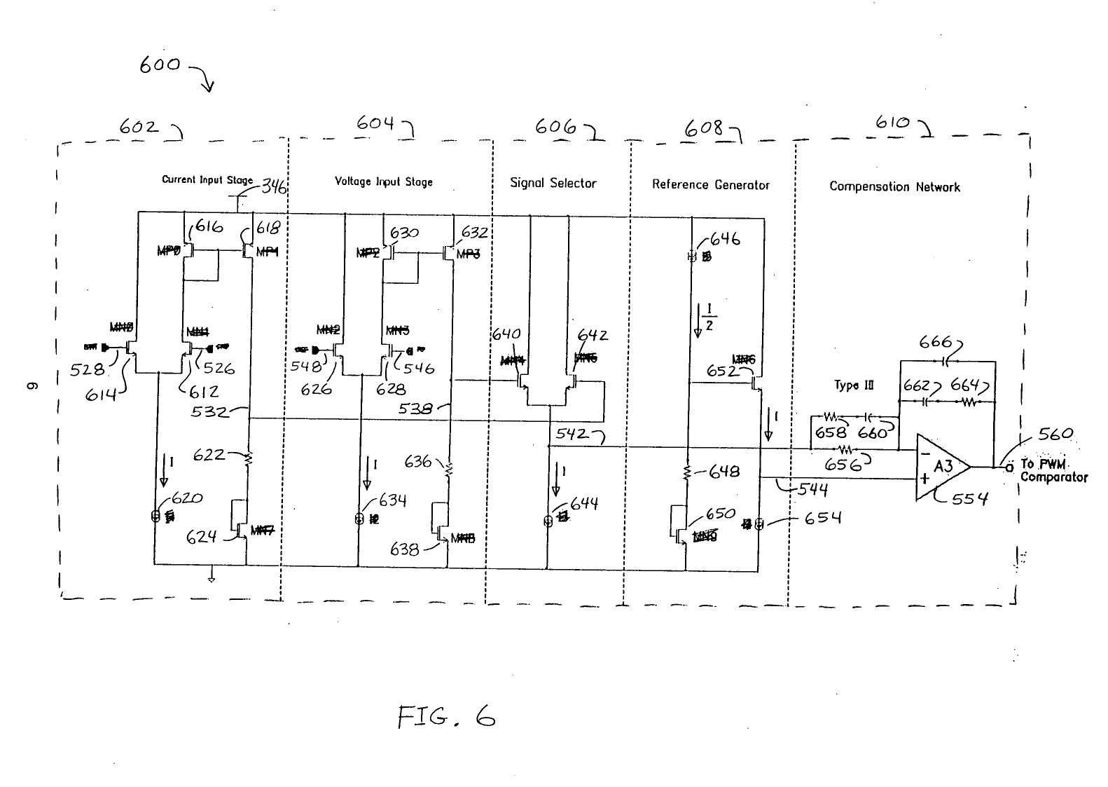

FIG. 6 illustrates an exemplary implementation 600 of the input stage 502 (having both current and voltage error amplifiers) and compensation amplifier stage 504 of battery charger 500 of FIG. 5 using MOS integrated circuit techniques. For simplicity, FIG. 6 omits elements such as reference voltage generators 330, 332, output stage 306, and current and voltage sensing resistors 320, 322, 324, shown in FIG. 5 and which can be constructed in accordance with known techniques.

The differential voltage representing current, which goes to near-zero when the output current is at its target value, connects to input 526 and input 528, connected to MOS transistors 612 and 614, respectively, in a current input stage 602. Transistors 612, 614 are configured as a differential pair, with a current source 620 providing current to the common source node for transistors 612, 614. A current mirror comprising transistors 616, 618 causes the current in resistor 622 to equal that in transistor 612. The resulting voltage at output 532 is an amplified version of the difference between the voltages at inputs 526, 528, with a nominal gain of suitably 10 to 20 dB.

Similarly, the differential voltage representing output voltage, which goes to near-zero when the output voltage is at its target value, is connected to inputs 546 and 548, then to MOS transistors 628 and 626, respectively, in a voltage input stage 604. Transistors 628, 626 are configured as a differential pair, with a current source 634 providing current to the common source node for transistors 628, 626. A current mirror comprising transistors 630, 632 causes the current in resistor 636 to equal that in transistor 630. The resulting voltage at output 538 is an amplified version of the difference between the voltages at inputs 546, 548, with a nominal gain of suitably 10 to 20 dB.

Signal selector circuitry 606 comprises a differential pair of transistors 640 and 642, whose sources are connected together and provided with current by a current source 644, in a signal selector stage 606. Inputs 532 and 538 are applied to the gates of transistors 640, 642, respectively. Inputs 532, 538 are at a nominal voltage near mid-supply only when the differential inputs of the respective input stages 602 and 604 are near zero volts. Inputs 532, 538 will both be near this nominal voltage at the transition from CC to CV mode. At other times, one of 532 and 538 will be at a relatively very low voltage, while the other will seek that voltage required to keep the current in resistor 512 or voltage at output 516 near its target value (as appropriate depending on CC or CV mode). The lower of the two inputs 532 and 538 will cause the transistor connected to it to be turned off, and all the current of source 644 will flow through the other transistor. The non-cut-off transistor will act as a source follower, and present to the output 542 the selected higher of the two voltages from outputs 532, 538.

A reference generator stage 608 provides a stable reference voltage at output 544 for the non-inverting input of compensation amplifier 554 (see FIG. 5). This reference voltage is selected to be equal to that voltage at output 542 when either the differential voltage at inputs 526-528 or differential voltage at inputs 546-548 is near zero (indicative of output current or voltage at its target value). For example, with equal voltages at inputs 526 and 528, and with output 538 near zero, the current indicated by “I” in FIG. 6 is split between transistor 614 and transistor 612, causing current of I/2 to flow in transistor 616. The current mirror topology causes a current I/2 to flow in transistor 618, generating the nominal steady state voltage at output 532, representative of the output current being at its target value. A static reference current of I/2 from source 646 produces this same voltage for use as a reference at output 544, due to the equivalence of topology and element values in the input stage and the reference generator, namely 622-648, 624-650, 642-652, and 644-654. Transistor 640 is effectively out of the circuit because it is cut off. The reference voltage at output 544 so derived has the same sensitivity to temperature and process variation as the voltage at output 542. Temperature and process variation effects are therefore cancelled out.

This cancellation of temperature and process effects on the reference voltage (and hence output target current or voltage) is another benefit of the active compensation network used in the present disclosure.

The reference voltage at output 544 is input to the non-inverting input of amplifier 554. The voltage at output 542 of the signal selector represents the amplified error between either output current or voltage and their respective targets (depending on CC or CV mode). This error voltage is further amplified and filtered by compensation network 610 comprising amplifier 554 and its feedback components 656, 658, 660, 662, 664, 666. The output 560 of the compensation network, appropriately tailored in amplitude and phase response, is then input to the PWM comparator 350 as previously described.

The topology shown for elements 656, 658, 660, 662, 664, 666 forms a Type III filter, which allows tailoring of both the amplitude response and phase response. Amplitude response of the configuration shown is decreasing with frequency (low-pass filter characteristic); phase response has increasing phase lag with increasing frequency, with a range of constant phase (lead/lag canceling). This range of constant delay typically coincides with the unity-gain frequency of the closed loop. The ability to carefully tailor the phase response (by choice of the resistor and capacitor values) gives much more precise control of loop stability and transient response than simpler topologies. It is an advantage of the described embodiment to be able to share a single Type III loop filter between both the current control and voltage control loops. It is also advantageous to have the capacitor in this type III loop filter in a feedback loop around an active device (the active compensation network), because the capacitance required for a desired loop response is far smaller than that required by the passive compensation used in much of the known art.

The novel topology described above allows the integration of a constant current/constant voltage battery charger circuit in significantly less die area than known art. It retains the performance advantages of an active compensation amplifier (ratiometric gain setting, small passive components), without the disadvantage of needing two such amplifiers each with associated passive elements. The selection of which output parameter to control (current or voltage) is made automatically by a signal selector having an input error signal from each parameter to be controlled.

The topology with its advantages can be applied to other feedback systems wherein a plurality of output parameters must be controlled, one at a time. If each controlled parameter is constrained to equal or less than a target maximum value, and the rise in any parameter above its target level causes the fall of all other parameter levels, the signal selector and single compensation amplifier described herein can be used effectively. Alternative signal selection methods could be used for signals not meeting said constraint, while still allowing said single compensation amplifier to be used. Parameters other than electrical signals could also be controlled, e.g. temperature, position, and physical properties.

The disclosed embodiments described above provide, in one aspect, an electrical circuit having an output current source providing electrical current to a load and responsive to a control input; a current sensing element through which the output current from the output current source passes, the current sensing element producing a signal proportional to the output current; a current error amplifier amplifying the difference between the signal from the current sensor and a first reference level; a voltage sensing element connected to the output of the current source, the voltage sensing element producing a signal proportional to the output voltage; a voltage error amplifier amplifying the difference between the signal from the voltage sensor and a second reference level; a compensation amplifier comprising an amplifier with resistive or reactive elements in a feedback configuration; the output of the compensation amplifier having a driving connection to the control input of the output current source; a signal selector having a driven connection with the outputs of each of the current and voltage error amplifiers, the signal selector passing one or the other of the output signals from the error amplifiers to the compensation amplifier.

The disclosed embodiments described above provide, in another aspect, a battery charger system controlling, alternatively, either charger output current or output voltage, holding either to its unique reference value appropriate to the battery being charged, during an appropriate time interval; having an output current sensor having a driving connection with the battery to be charged, a second driving connection with the first input of a current error difference amplifier, and through which the charger output current flows; a current reference generator indicative of a desired or target current level, having a driving connection to the second input of a current error difference amplifier; the current error difference amplifier, having a driving connection with the first input of a signal selector, and providing a current error signal indicative of the difference between the output current and the current reference target value; an output voltage sensor, having a driven connection with the charger output, and a driving connection with the first input of a voltage error difference amplifier; a voltage reference generator indicative of a desired or target voltage level, having a driving connection to the second input of a voltage error difference amplifier; the voltage error difference amplifier, having a driving connection with the second input of a signal selector, and providing a voltage error signal indicative of the difference between the output voltage and the voltage reference target value; the signal selector, autonomously selecting either the current or voltage error signal, and having a driving connection with a single compensation amplifier; the compensation amplifier, having feedback to ratiometrically tailor amplitude and phase response, further amplifying and modifying the phase and frequency response of the selected measure of current or voltage error; a voltage controlled current source means having a driven connection with the compensation amplifier, and responsive to the amplified and modified measure of error, such that alternatively the charger output current or voltage is held at a desired value, and having a driving connection with the input of the current sensor; wherein the improvement comprises the signal selector means and the single compensation amplifier means.

The signal selector may be a diode “OR” circuit which passes the higher of two voltages applied to it, ignoring the lower voltage.

The signal selector may be a circuit comprising two transistors with common source node, the node also being connected to a current source providing a constant current to or from the node; with drains of both transistors connected to a supply voltage greater in magnitude than the highest voltage to be applied to either gate; and with signals to be selected each connected to one of the gates; such that the first transistor having the lower of the two inputs will be cutoff, and the second transistor will act as a source follower, passing the higher of the two voltages to the common source node which is the output of the selector.

The signal selector may be a circuit comprising two transistors with common emitter node, the node also being connected to a current source providing a constant current to or from the node; with collectors of both transistors connected to a supply voltage greater in magnitude than the highest voltage to be applied to either base; and with signals to be selected each connected to one of the bases; such that the first transistor having the lower of the two inputs will be cutoff, and the second transistor will act as an emitter follower, passing the higher of the two voltages to the common emitter node which is the output of the selector.

The output current sensor may be a resistor through which the output current flows, generating a voltage across the resistor proportional to the current through it.

The output current sensor may be a Hall effect device through which the output current flows, generating a voltage proportional to the current through it.

The compensation amplifier may be a high-gain differential input amplifier (of the type commonly referred to as operational amplifier) having reactive input and feedback elements which serve to precisely control amplitude and phase response versus frequency of the amplifying network.

The disclosed embodiments described above provide, in another aspect, a circuit comprising a current input stage, a substantially identical voltage input stage, a signal selector stage having as inputs the two outputs of the input stages, a reference generator stage, and a compensation network stage having as inputs the output of the signal selector and the output of the reference generator.

The current input stage may have a differential input voltage indicative of the current flowing from or to a node, and which voltage approaches zero as the current approaches a desired target value; the input stage comprising a first and second differentially-connected pair of transistors, with common source node connected to a current source, and with the differential input voltage being connected to the two gates; with the drain of the first transistor of the differential pair being connected to a supply voltage, and the drain of the second transistor of the pair being connected to the drain and gate of a third transistor and the gate of a fourth transistor; the source of both the third and fourth transistor being connected to the supply voltage; the drain of the fourth transistor being connected to the output node and a first terminal of a resistor; the second terminal of the resistor being connected to both the gate and drain of a fifth transistor with source connected to ground.

The voltage input stage may have a differential input voltage indicative of the voltage on the node, and which voltage approaches zero as the voltage approaches a desired target value; the input stage comprising a first and second differentially-connected pair of transistors, with common source node connected to a current source, and with the differential input voltage being connected to the two gates; with the drain of the first transistor of the differential pair being connected to a supply voltage, and the drain of the second transistor of the pair being connected to the drain and gate of a third transistor and the gate of a fourth transistor; the source of both the third and fourth transistor being connected to the supply voltage; the drain of the fourth transistor being connected to the output node and a first terminal of a resistor; the second terminal of the resistor being connected to both the gate and drain of a fifth transistor with source connected to ground.

The signal selector may include first and second transistors with common sources, the common sources also being connected to the output of the signal selector and a current source to ground; and having as input to the gate of the first transistor the output of the current input stage, and having as input to the gate of the second transistor the output of the voltage input stage; the drains of both first and second transistors being connected to the supply voltage.

The reference generator may include a first transistor with source connected to ground and with gate and drain connected together and to a first terminal of a resistor; the second terminal of the resistor being connected to the first terminal of a first current source and to the gate of a second transistor; the second terminal of the first current source being connected to the supply voltage; the drain of the second transistor being connected to the supply voltage; the source of the second transistor being connected to the reference generator output and to the first terminal of a second current source, with second terminal of the second current source being connected to ground.

The compensation network may include a differential amplifier with non-inverting input connected to the output of the reference generator; first resistor having first terminal connected to the output of the signal selector and to the first terminal of a second resistor; the second terminal of the first resistor being connected to the inverting input of the differential amplifier, the second terminal of a first capacitor, the first terminal of a second capacitor, and the first terminal of a third capacitor; the second terminal of the second capacitor being connected to the first terminal of the third resistor; the second terminal of the second resistor being connected to the first terminal of the first capacitor; the second terminal of the third capacitor being connected to the second terminal of third resistor and the output of differential amplifier which is also the output of the compensation network.

Those skilled in the art to which the invention relates will appreciate that yet other substitutions and modifications can be made to the described embodiments, without departing from the spirit and scope of the invention as described by the claims below.

1. Apparatus and methods substantially as described and disclosed.
